(19) United States
(12) Patent Application Publication
(10) Pub. No.: US 2016/0309290 A1
(43) Pub. Date: Oct. 20, 2016

(54) SYSTEM AND METHOD FOR MATCHING

(71) Applicants: Xiran Wang, West Lafayette, IN (US); Kevin Hwading Chu, Houston, TX (US); Yangyang Chen, Houston, TX (US)

(72) Inventors: Xiran Wang, West Lafayette, IN (US); Kevin Hwading Chu, Houston, TX (US); Yangyang Chen, Houston, TX (US)

(73) Assignee: IMAGINE IF, LLC, Houston, TX (US)

(21) Appl. No.: 14/791,248

(22) Filed: Jul. 2, 2015

Related U.S. Application Data
(63) Continuation-in-part of application No. 14/688,264, filed on Apr. 16, 2015.

(51) Int. Cl. H04W 4/02; H04L 29/08

(52) U.S. Cl. CPC H04W 4/021; H04W 4/023; H04L 67/20; H04L 67/306

(57) ABSTRACT

A system including: a first computing device, a second computing device, a server having a processor, the processor is configured to: (a) determine a first location of the first computing device associated with a first user, (b) determine a second location of the second computing device associated with a second user, (c) determine that the first location and the second location are located within a geo-fence, (d) determine that a distance between the first location and the second location is less than a first threshold, (e) increase a counter count, (f) determine that the counter count is greater than a second threshold, (g) prompt the first user and the second user to match, and a database configured to store a mapping between the first user and the second user.

### RESERVATION OF COPYRIGHTS

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Technology was supposed to connect us, but we are more disconnected than ever. We see the world through computing devices; we converse with one another not face-to-face, but through virtual chatrooms. One or more embodiments of the present invention connect individuals.

### SUMMARY

In general, in one aspect, one or more embodiments disclosed herein relate to a system comprising: a first computing device; a second computing device; a server having a processor, the processor is configured to: (a) determine a first location of the first computing device associated with a first user, (b) determine a second location of the second computing device associated with a second user, (c) determine that the first location and the second location are located within a geo-fence, (d) determine that a distance between the first location and the second location is less than a first threshold, (e) increase a counter count, (f) determine that the counter count is greater than a second threshold, (g) prompt the first user and the second user to match; and a database configured to store a mapping between the first user and the second user.

In another aspect, one or more embodiments disclosed herein relate to a method comprising: (a) determining a first location of a first computing device associated with a first user; (b) determining a second location of a second computing device associated with a second user; (c) determining that the first location and the second location are located within a geo-fence; (d) determining that a distance between the first location and the second location is less than a first threshold; (e) increasing a counter count; (f) determining that the counter count is greater than a second threshold; (g) prompting the first user and the second user to match; and (h) storing a mapping between the first user and the second user.

In yet another aspect, one or more embodiments disclosed herein relate to a non-transitory computer readable medium comprising computer readable program code, which when executed by a computer processor, enables the computer processor to: (a) determine a first location of a first computing device associated with a first user; (b) determine a second location of a second computing device associated with a second user; (c) determine that the first location and the second location are located within a geo-fence; (d) determine that a distance between the first location and the second location is less than a first threshold; (e) increase a counter count; (f) determine that the counter count is greater than a second threshold; (g) prompt the first user and the second user to match; and (h) store a mapping between the first user and the second user.

Other aspects and advantages of the present invention will be apparent from the following description and the appended claims.

### BRIEF DESCRIPTION OF DRAWINGS

FIG. 1 shows a matching system according to one or more embodiments of the present invention.

FIG. 2A shows a matching system according to one or more embodiments of the present invention.

FIG. 2B shows a matching system according to one or more embodiments of the present invention.

FIG. 3 shows a matching method according to one or more embodiments of the present invention.

FIG. 4A shows a matching application according to one or more embodiments of the present invention.

FIG. 4B shows a matching application according to one or more embodiments of the present invention.

FIG. 4C shows a matching application according to one or more embodiments of the present invention.

FIG. 4D shows a matching application according to one or more embodiments of the present invention.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description, numerous specific details are set forth in order to provide a more thorough understanding of one or more embodiments of the present invention. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a component surface” includes reference to one or more of such surfaces.

Terms like “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

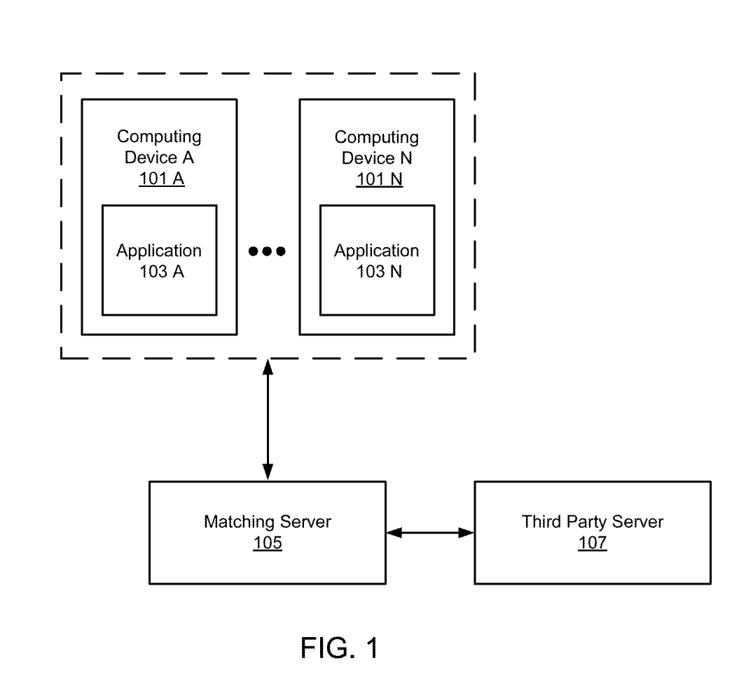

FIG. 1 shows a matching system according to one or more embodiments of the present invention. As shown in FIG. 1, the system has multiple components including one or more computing devices (101A, 101N) each running an application (103A, 103N), a matching server (105), and a third party server (107). As also shown in FIG. 1, various components of the system may communicate directly or indirectly with one another. The communication may be exchange of information, storage of information, etc. The information within the system described herein may be stored in one or more data structures.

Further, any data structure type (e.g., arrays, linked lists, hash tables, etc.) may be used to organize information within the data structure(s) provided that the data structure type(s) maintain the various exchange of information described. Each of these components is described below.

In one or more embodiments of the present invention, each computing device (101A, 101N) may be a desktop personal computer (PC), a laptop, a tablet computer, an electronic reader (e-reader), a cable box, a kiosk, a smart phone, a server, a mainframe, a personal digital assistant (PDA), or any other type of hardware device. Each device may include a processor, persistent storage, and a memory to execute the one or more applications (103A, 103N). The device may communicate (directly or indirectly) with the matching server (105) and/or with the third party (107) using any wired and/or wireless (e.g., will, cellular, etc.) connections.

In one or more embodiments of the present invention, the computing device (101A, 101N) may also include one or more input device(s) (not shown), such as a touchscreen, keyboard, mouse, microphone, touchpad, electronic pen, or any other type of input device. Further, the computing device (101A, 101N) may include one or more output device(s) (not shown), such as a screen (e.g., a liquid crystal display (LCD), a plasma display, touchscreen, cathode ray tube (CRT) monitor, projector, or other display device, a printer, external storage, or any other output device. One or more of the output device(s) may be the same or different from the input device(s). Many different types of computing systems exist, and the aforementioned input and output device(s) may take other forms.

In one or more embodiments of the present invention, the application (103A, 103N) may be a software application of any type (e.g., operating system, messaging application, social media application, game, word processing application, web browser, etc.). The application may be implemented to include one or more advertisement placements. An advertisement placement is a predefined space in an application used to display one or more native or non-native online advertisements. For example, the advertisement placement may be a specific location within the user interface of an application. In another example, the advertisement placement may be associated with a feature in the application, e.g., in a news feed, a user profile message board, a message feed, or a stream. In one or more embodiments of the present invention, the stream is a presentation of, list of, or other organization of content within application (103A, 103N). The stream may include both content and ads (which may include native ads). For purposes of discussion only, we assume hereon that the application (103A, 103N) is associated with the matching server (105).

In one or more embodiments of the present invention, the matching server (105) may be implemented on hardware device that includes a memory and a processor. The matching server (105) is operatively connected to the application (103A, 103N), and the third party server (107).

In one or more embodiments of the present invention, the third party server (107) is a server owned by an entity different from the entity associated with the matching server (105). In one or more embodiments, the third-party server (107) may be associated with a social media platform.

Those skilled in the art will appreciate that while FIG. 1 shows a particular system configuration, the disclosure is not limited to the aforementioned system configuration.

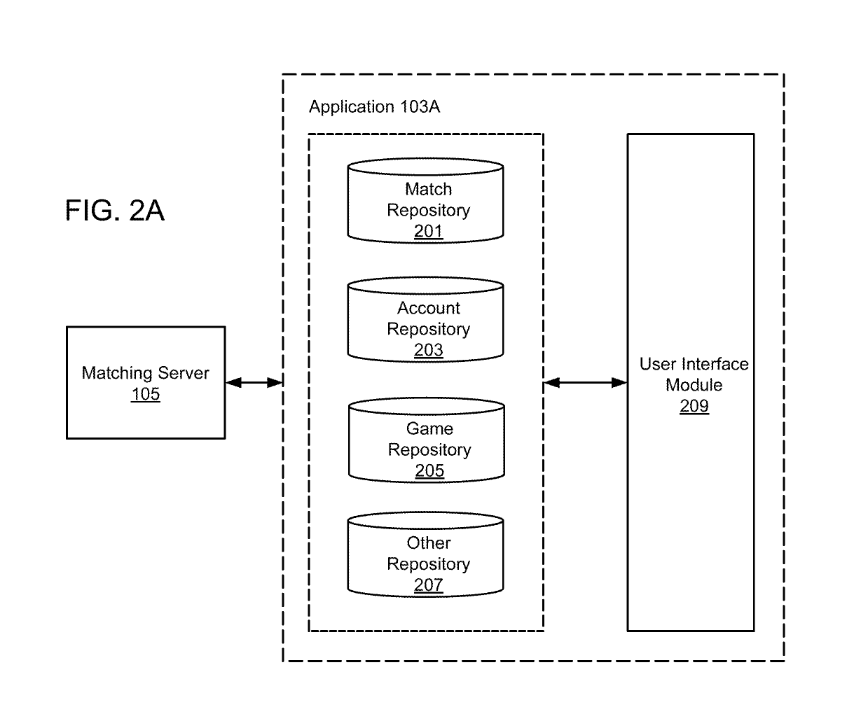

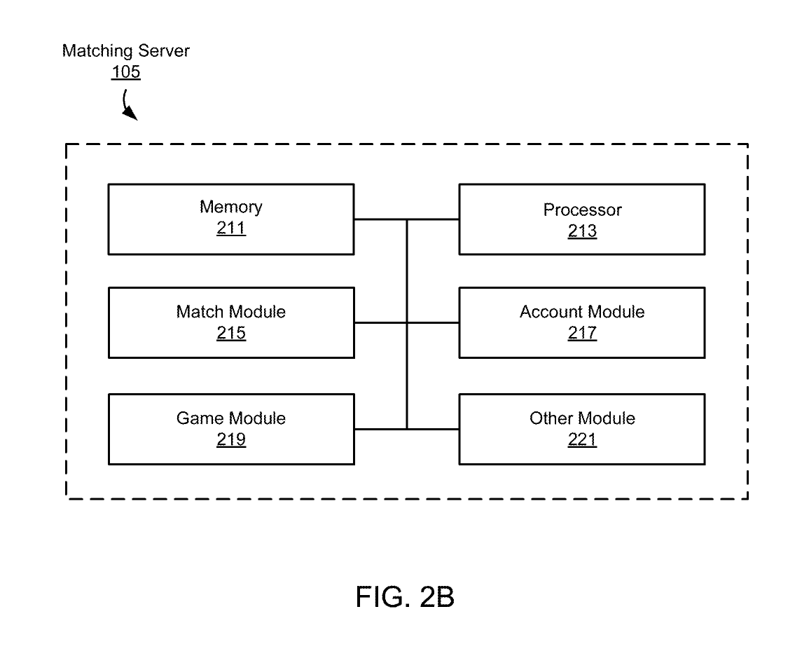

FIG. 2A shows a matching system according to one or more embodiments of the present invention. Components that have already been described will be omitted for the sake of brevity. As shown in FIG. 2A, the system has multiple components including an application (103A) of a computing device and a matching server (105). Each of these components is described below.

In one or more embodiments of the present invention, the application (103A) may comprise a matching repository (201), an account repository (203), a game repository (205), an other repository (207), and a user interface module (209).

One or more of the repositories reside on one or more servers. In the case that the repository physically resides on one or more servers separate from the computing device (101A), the repository within the application (103A) may communicate directly or indirectly with its corresponding repository on the one or more servers. In one or more embodiments of the disclosure, the data repositories may reside on the computing device (101A) executing the application (103A).

In one or more embodiments of the present invention, the match repository (201) includes data entries including whether two people have been matched, scores scoring a relationship between two people, whether a restriction has been imposed (e.g., whether one has black-listed another, whether one has rejected an offer to pair up with another, etc.). The match repository may also store information associated with each match (e.g., encounter location and an associated timestamp, matched location and an associated timestamp). Even after a pair has been matched, the matching repository may continue to store subsequent encounter locations. In one or more embodiments, the matching repository may be associated with, connected operatively to, and/or be a part of a database. Further, the database may or may not be physically separate from the database.

In one or more embodiments of the present invention, the account repository (203) includes information of the user using the application (103A) (e.g., age, location, sexual preferences, sexual orientation, gender, personal information, contact information, etc.). In one or more embodiments, the account repository may be associated with, connected operatively to, and/or be a part of a database.

In one or more embodiments of the present invention, the game repository (203) includes mini-games that can be played matched pairs. The contents of mini-games are not limited. Mini-games may be licensed from a third-party server (107).

In one or more embodiments of the present invention, the other repository (207) may be a payment repository configured to store payment information (e.g., credit card information, gift card information, bank account information, etc.). In one or more embodiments of the present invention, the other repository (207) may be a search repository configured to communicate with third-party servers to retrieve restaurant recommendations, shopping deals, event specials, etc., associated with a geo-fence.

In one or more embodiments of the present invention, the other repository (207) may be a chat room repository, a live feed repository, etc.

In one or more embodiments of the present invention, a user interface module (209) is provided. The user interface module (209) aggregates the repositories associated with the application (103A) and compiles the repositories into a presentable format.

Those skilled in the art will appreciate that while FIG. 2A shows a particular system configuration, the disclosure is not limited to the aforementioned system configuration.

FIG. 2B shows a matching system according to one or more embodiments of the present invention. Components that have already been described will be omitted for the sake of brevity. As shown in FIG. 2B, the matching server (105) has multiple components. Each of these components is described below.

The matching server (105) may comprise a memory (211), a processor (213), a matching module (215), an account module (217), a game module (219), and an other module (221).

In one or more embodiments of the present invention, the memory (211) may be, for example, random access memory (RAM), cache memory, flash memory, etc.

In one or more embodiments of the present invention, the processor (213) may be an integrated circuit for processing instructions. For example, the processor (213) may be one or more cores, or micro-cores of a processor.

In one or more embodiments, the matching module (215) may correspond substantially to the matching repository (201); the same be same of other module-repository pairs. Accordingly, redundant details are omitted for the sake of brevity.

In one or more embodiments of the present invention, the matching server (105) may further comprise a storage (e.g., a hard disk, an optical drive such as a compact disk (CD) drive or digital versatile disk (DVD) drive, a flash memory stick, etc.).

Those skilled in the art will appreciate that while FIG. 2B shows a particular system configuration, the disclosure is not limited to the aforementioned system configuration.

Turning to the flowcharts, while the various steps in the flowcharts are presented and described sequentially, one of ordinary skill will appreciate that some or all of the steps may be executed in different orders, may be combined or omitted, and some or all of the steps may be executed in parallel.

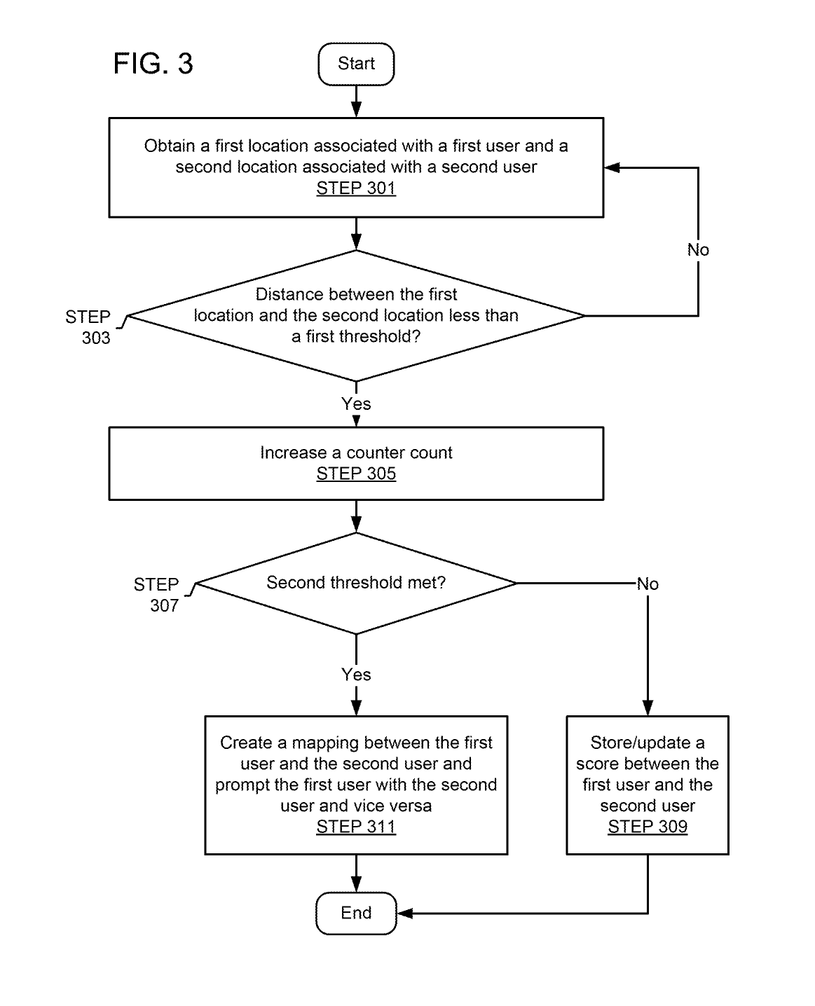

FIG. 3 shows a matching method according to one or more embodiments of the present invention. The method shown in FIG. 3 may be implemented by the matching server (215). The method shown in FIG. 3 may be implemented by hardware, software, or a combination thereof.

In Step 301, a first location of a first computing device associated a first user and a second location of a second computing device associated with a second user are obtained. In one or more embodiments of the present invention, Step 301 may further comprise determining that the first location and the second location are located within a geo-fence. Specific methods for determining a location of a computing device are not limited and may, for example, be a global positioning system. One of ordinary skill in the art would appreciate that cellular connections, wifi connections, etc., may also be possible.

In Step 303, a distance between the first location and the second location is computed. Further, the distance is compared to a first threshold. The first threshold may be adjustable depending on various factors, including the population density of the geo-fence that encompasses the first location and the second location. The first threshold may be adjusted based on user preference. The first threshold may be adjusted in increments of a mile; alternatively, the first threshold may be adjusted on a continuous basis using a radio dial interface. If the distance falls below the first threshold, the flowchart may continue to Step 305. Otherwise, the flowchart may continue to Step 301 or simply end.

One or more embodiments of the present invention define a “geo-fence” as a virtual barriers. The geo-fences may be set up according to population density/distribution and may conform to administrative divisions depending on local/national governments.

In Step 305, a counter may be increased when it has been detected that the distance between the first location and the second location falls below the first threshold. In one or more embodiments, a user may specify the count to be increased only when the distance falls below the first threshold for a predetermined period of time. In one or more embodiments, the counter is limited to increasing once a predetermined period of time (i.e., counter does not increase more than once a day, etc.).

In Step 307, the method determines whether a second threshold has been met. In one or more embodiments, the second threshold may be a threshold for the counter count (i.e., the method may determine whether the counter count has counted more than 10, etc.). The second threshold may also be adjustable depending on user preference. If the second threshold is met, the flowchart may continue to Step 311. Otherwise, the flowchart may continue to Step 309.

In Step 309, the counter count for the two users is stored/updated.

In Step 311, a mapping between first user and the second user is created and the first user and the second user are prompted to match. With respect to the mapping, there exist at least three types of mappings: (1) If the users are prompted to match and are matched, a first type mapping may comprise information including all the approximate places that caused the counter increase (distance between the first location and the second location falling below the first threshold). The location may be a center point between the two user locations when the distance falls below the first threshold. The location may be the location having the shortest distance between the first user and the second user. (2) The second threshold is not yet met (accordingly, the user has not been prompted to match). A second type mapping may comprise information including a counter count, locations that caused the counter count to increase. (3) If the users are prompted to match and one of the users reject to match, then the mapping may be a third type mapping. Specifically, a relationship between the two individuals may be labelled as restricted or blacklisted, Thereafter, the users may be prohibited from communicating with one another. For the two users, the counter count becomes irrelevant and may be erased, as may be information pertinent to the two (including locations that caused the counter count to increase).

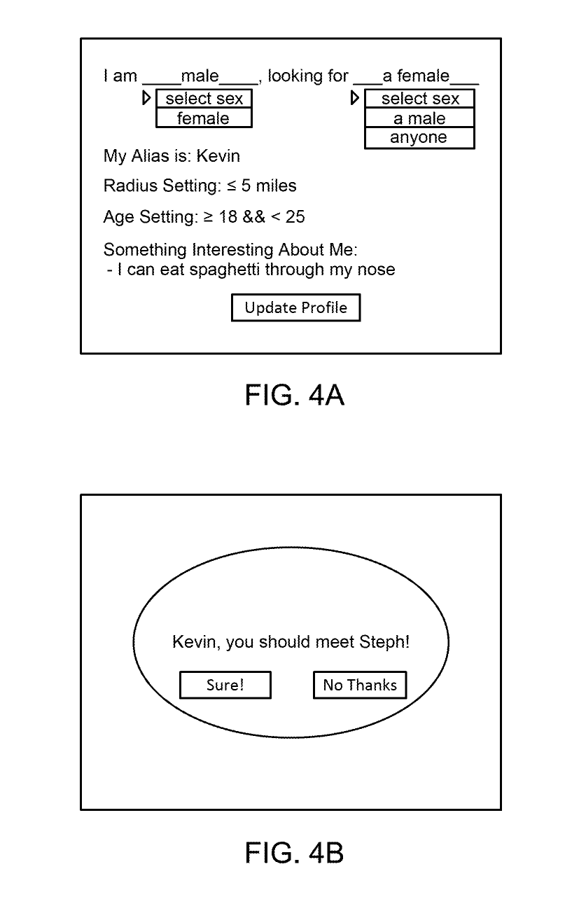

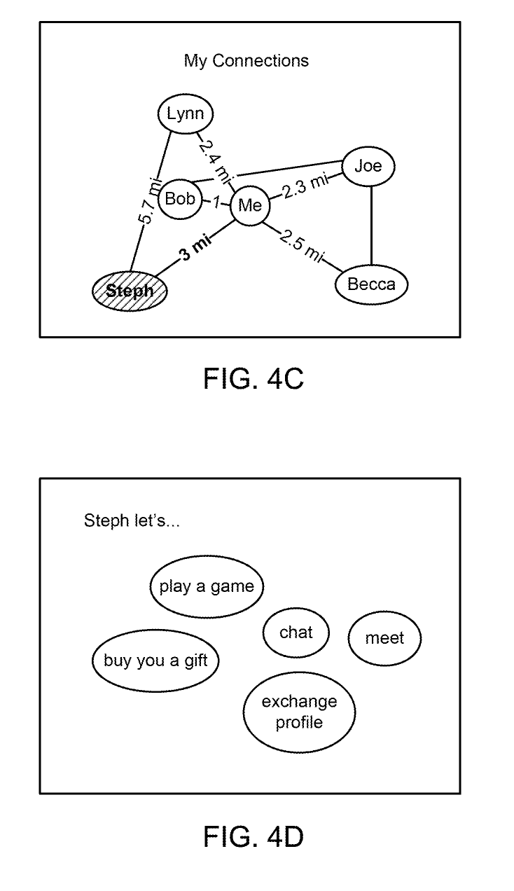

FIG. 4A shows a matching application according to one or more embodiments of the present invention.

Specifically, FIG. 4A shows a page of the matching application. For example, a user is able to input his potential match criteria. The user may indicate his or her own gender and indicate who he or she is looking for (e.g., based on gender, distance, age, etc.). The user is also able to disclose something interesting about him or herself.

FIG. 4B shows a matching application according to one or more embodiments of the present invention.

Specifically, FIG. 4B shows a page of the matching application. The user Kevin is prompted to meet Steph. This is a screen shown when it has been determined that the second threshold (See Step 307) has been met. If Kevin selects “Sure!,” Kevin and Steph are matched and a first type mapping is created. If Kevin or Steph selects “No Thanks,” Kevin and Steph are not matched and a third type mapping is created.

FIG. 4C shows a matching application according to one or more embodiments of the present invention.

Specifically, FIG. 4C shows a page of the matching application. Subsequent to both users agreeing to match (See FIG. 4B), the application may display a connection page showing all the connections of the user. FIG. 4C is from Kevin's perspective. As shown, Kevin is connected to Bob, Lynn, Joe, and Becca, who are 1 mile, 2.4 miles, 2.3 miles, and 2.5 miles away from Kevin, respectively. For privacy concerns, the exact location of these individuals may or may not be displayed to Kevin. As can also be seen in FIG. 4C, Steph is a newly added connection and is shaded accordingly. Steph is 3 miles from Kevin.

As also shown in FIG. 4C, Kevin is able to see whether his friends are connected to other of his connections on the application. In this case, Joe is also connected to Bob and Becca. A distance between Joe and Becca may or may not be shown to Kevin depending on individual privacy settings.

In one or more embodiments, Kevin may select one or more of his connections to engage in certain activities with him. Some activities may be located within the geo-fence. For example, Kevin and Steph may purchase movie tickets for a cinema located within the geo-fence. In one or more embodiments, the activities available to the two users may change depending on the counter count. The higher the counter count, we assume that there is greater intimacy between the two. Accordingly, intimate matches with high counter counts may be able to unlock, for example, “go to pub,” “book hotel,” etc., as an activity.

For example, by using a finger motion to link Lynn, Joe, and Becca, a group chatroom having the users including Kevin may be created. For example, by using a finger to draw out a cross (e.g., X) on the “Joe” bubble, Kevin and Joe may be unmatched and the first type mapping between the two may be converted to the third type mapping.

FIG. 4D shows a matching application according to one or more embodiments of the present invention.

By selecting, for example, the “Steph” bubble in FIG. 4C. Kevin may be able to do activities with Steph. Activities include, but are not limited to, “play a game,” “buy [Steph] a gift,” “chat,” “meet (i.e., set a meeting location),” “exchange profile,” etc.

Selecting “play a game” may open up a menu. The menu lists a plurality of games that Kevin and Steph may play. One game, for example, may be to guess the location of the other user. The game may proceed by providing location hints of the user. Whoever identifies the other user first may be determined to be the winner.

Selecting “buy you a gift” may direct the user to a shopping portal. The portal may or may not be run by a third-party server.

Selecting “chat” may open up a chat window that enables Kevin and Steph to chat.

Selecting “meet” may open up a map that enables Kevin and Steph to choose a meeting location.

Selecting “exchange profile” may enable Kevin and Steph to exchange their respective profiles and/or give each other access to the person's third-party social media profile pages.

While the disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the disclosure has been described with respect to one or more embodiments of the present invention, those skilled in the art, having benefit of this disclosure, will appreciate that other embodiments can be devised which do not depart from the scope of the disclosure as disclosed herein.

For example, if two individuals have not caused a counter count to increase for a predetermined period of time, the counter count may decrease.

For example, the second threshold may not be a counter count, and, instead, may be solely based on distance.

For example, the counter count may not be increased if the system and method determine that there is not a mutual friend between the two users. The system and method may determine whether there is a mutual friend between the two users based on data from the database or based on data from a third party server associated with a social media platform.

For example, the counter count may not be increased if the system and method determine that there is not a mutual interest between the two users. The system and method may determine whether there is a mutual interest between the two users based on data from the database or based on data from a third party server associated with a social media platform.

For example, activities not shown in FIG. 4D may be possible. For example, “book restaurant,” “visit zoo,” etc. The application may collaborate with third-party servers to provide the users with applicable coupons.

For example, an overriding rule may prompt two users to match even if not all the preset conditions have been met. For example, the two users may be prompted to match if a distance between the first user and the second user is less than a third threshold (the third threshold being less than the first threshold, for example).

For example, alternatively, or in addition to showing distances between the user and his or her connections, the application may only show the regions in which his or her connections are located at. The regions may be outlined using a map. For example, the map may be a heat map that shows the regions in which the connection is the most active (in comparison to those that are not so active).

Furthermore, one of ordinary skill in the art would appreciate that certain “components,” “modules,” “units,” “parts,” “elements,” or “portions” of the one or more embodiments of the present invention may be implemented by a circuit, processor, etc., using any known methods. Accordingly, the scope of the disclosure should be limited only by the attached claims.

1. A communication system comprising:
a first user equipment;
a second user equipment; and
a radio base station apparatus having a processor, a location detection circuit, and an antenna that transmits and receives communication signals from the first user equipment and the second user equipment,
wherein, upon determining that the first user equipment and the second user equipment reside in a geo-fence, the radio base station apparatus is configured to:
ping the first user equipment using the location detection circuit to determine a first distance between the radio base station and the first user equipment,
ping the second user equipment using the location detection circuit to determine a second distance between the radio base station and the second user equipment,
using the first distance and the second distance, determine that a distance between the first user equipment and the second user equipment is less than a first threshold and increase a first counter count, and
wherein, upon the first counter count exceeding a second threshold, the base station establishes a secure communication channel between the first user equipment and the second user equipment.

2. (canceled)

3. (canceled)

4. The communication system according to claim 1, wherein the processor is further configured to:
determine that the secure communication has been established, and
display an activity on each of the first user equipment and the second user equipment.

5. The communication system according to claim 4, wherein the activity is located within the geo-fence.

6. The communication system according to claim 5, wherein the processor is further configured to generate a coupon associated with the activity and display the coupon on the first user equipment.

7. The communication system according to claim 4, wherein the activity is one selected from the group consisting of initiating a chat, initiating a game, gifting, transmitting a user profile, setting a meeting location, and a combination thereof

8. The communication system according to claim 1, wherein, determine that upon the radio base station establishing the secure communication channel between the first user equipment and the second user equipment, the first user equipment is configured to display a distance between the first user equipment and the second user equipment.

9. The communication system according to claim 1, wherein the first threshold and the second threshold vary based on a population density of the geo-fence.

10. The communication system according to claim 1,
wherein the radio base station does not establish the secure communication channel when the first counter count exceeds the second threshold if the processor determines that there is not a second secure communication channel established between the second user equipment and a third user equipment, and
wherein a third secure communication channel has been established between the third user equipment and the first user equipment.

11-15 (canceled)

16. The communication system according to claim 1, wherein:
upon the radio base station establishing the secure communication channel between the first user equipment and the second user equipment, the first user equipment visually displays a connection between the first user equipment and the second
user equipment.

17. (canceled)

18. The communication system according to claim 4, wherein the activity changes based on the first counter count.

19. (canceled)

20. (canceled)
